(19) United States
(12) Patent Application Publication
(10) Pub. No.: US 2023/0397283 A1
(43) Pub. Date: Dec. 7, 2023

(54) METHODS FOR SIGNALLING USER EQUIPMENT ASSISTANCE INFORMATION, RELATED WIRELESS DEVICE, AND RELATED NETWORK NODE

(71) Applicant: Sony Group Corporation, Tokyo (JP)

(72) Inventor: Rickard LJUNG, Helsingborg (SE)

(21) Appl. No.: 18/033,343

(22) PCT Filed: Oct. 8, 2021
(86) PCT No.: PCT/EP2021/077910

§ 371 Date: Apr. 23, 2023

(30) Foreign Application Priority Data
Oct. 29, 2020 (SE) 2051259-6

(51) Int. Cl. H04W 76/19; H04W 76/20; H04W 74/08

(52) U.S. Cl. CPC H04W 76/19; H04W 76/20; H04W 74/0833

(57) ABSTRACT

Disclosed is a method, performed by a wireless device, for providing User Equipment, UE, assistance information to a network node. The method comprises communicating with the network node while the wireless device is in a dormant mode. The method comprises transmitting, to the network node, during a connection establishment procedure that brings the wireless device from the dormant mode to a connected mode, UE assistance information associated with a radio parameter for use in the connected mode.

The present disclosure pertains to the field of wireless communications. The present disclosure relates to a method for user equipment assistance information, related wireless device and related network node.

### BACKGROUND

In 3rg Generation Partnership Project, 3GPP, specifications, a wireless device (such as user equipment, UE) has multiple UE parameters to be configured with by a network node while being in the RRC connected state.

Several of the UE parameters have an impact on power consumption of the wireless device during the connection. Alternatively, or additionally, the selection of the parameter may impact the performance of the data transmission occurring while the wireless device is in a connected state. For example, the selection of the parameter may impact the achievable data rate, the variation of the data rate, and/or the end to end packet latency.

Approaches for signalling UE parameters from the UE present drawbacks in terms of efficiency.

### SUMMARY

Accordingly, there is a need for devices and methods for signalling UE assistance information, which mitigate, alleviate or address the shortcomings existing and provide a more efficient signalling for UE assistance information, which leads to a reduced latency in applying the UE parameter configuration favorable to the power consumption and performance of the wireless device, and to a reduced power consumption of the wireless device.

Disclosed is a method, performed by a wireless device, for providing User Equipment, UE, assistance information to a network node. The method comprises communicating with the network node while the wireless device is in a dormant mode. The method comprises transmitting, to the network node, during a connection establishment procedure that brings the wireless device from the dormant mode to a connected mode, UE assistance information associated with a radio parameter for use in the connected mode.

Further, a wireless device is provided, the wireless device comprising memory circuitry, processor circuitry, and a wireless interface, wherein the wireless device is configured to perform any of the methods disclosed herein.

Thereby, the disclosed wireless device can benefit from UE parameter configuration favorable to the power consumption and performance of the wireless device, in a time efficient manner, immediately after a connection establishment procedure that brings the wireless device from the dormant mode to a connected mode. Stated differently, the disclosed wireless device can inform the network node of its preferred radio parameter(s) e.g. prior to the usage of the RRC connection for data communication. The disclosed wireless device can benefit from a reduced power consumption and possibly improved performance e.g. in terms of achievable data rate, the variation of the data rate, and/or the end to end packet latency. The signalling disclosed herein is also more efficient in terms of amount of signalling exchanged, order and timing, than the legacy signalling.

Disclosed is a method, performed by a network node for receiving User Equipment, UE, assistance information from a wireless device in a dormant mode. The method comprises communicating with the wireless device. The method comprises receiving, from the wireless device, during a connection establishment procedure that brings the wireless device from the dormant mode to a connected mode, UE assistance information associated with a radio parameter for use in the connected mode.

Further, a network node is provided, the a network node comprising memory circuitry, processor circuitry, and a wireless interface, wherein the a network node is configured to perform any of the methods disclosed herein.

Thereby, the disclosed network node can apply UE parameter configuration favorable to the power consumption and performance of the wireless device, in a time efficient manner, immediately after a connection establishment procedure or a connection re-activation procedure that brings the wireless device from the dormant mode to a connected mode. The disclosed network node may not need to reconfigure the wireless device for the wireless device to apply a preferred radio parameter. In one or more examples, the network node may need to reconfigure the wireless device to apply a preferred radio parameter, where the reconfiguration signaling can be applied earlier in time if the preferred radio parameter is received by the network node within the connection re-activation or establishment procedure. For example, in a connection re-activation procedure, the disclosed network node is provided with the preferred radio parameter from the wireless device as part of the re-activation, prior to the RRC connection being used. The method may lead to reduced time delay for activating a preferred radio parameter. The method may lead to an overall reduced signalling from the network node and possibly improved performance e.g. in terms of achievable data rate, the variation of the data rate, and/or the end to end packet latency.

### BRIEF DESCRIPTION OF THE DRAWINGS

The above and other features and advantages of the present disclosure will become readily apparent to those skilled in the art by the following detailed description of example embodiments thereof with reference to the attached drawings, in which:

FIG. 1 is a diagram illustrating an example wireless communication system comprising an example network node and an example wireless device according to this disclosure,

FIG. 2 is a signalling diagram illustrating legacy signalling for enabling UE assistance

FIGS. 3A-3B are signalling diagrams illustrating example signalling exchanges for UE assistance information according to this disclosure,

FIG. 4 is a flow-chart illustrating an example method, performed by a wireless device, for providing UE assistance information to a network node according to this disclosure,

FIG. 5 is a flow-chart illustrating an example method, performed by a network node, for receiving UE assistance information from a wireless device according to this disclosure,

FIG. 6 is a block diagram illustrating an example wireless device according to this disclosure, and

FIG. 7 is a block diagram illustrating an example network node according to this disclosure.

### DETAILED DESCRIPTION

Various example embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

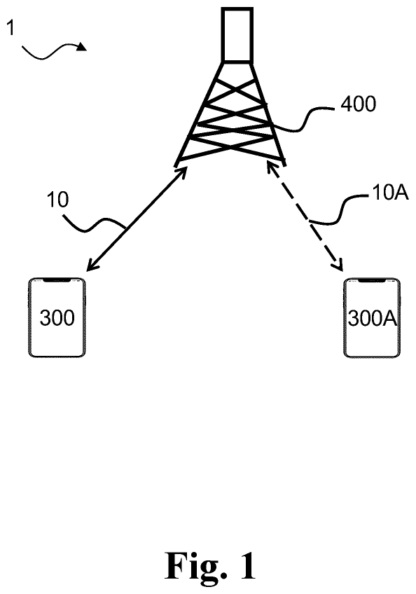

FIG. 1 is a diagram illustrating an example wireless communication system 1 comprising an example network node 400 and an example wireless device 300 according to this disclosure.

As discussed in detail herein, the present disclosure relates to a wireless communication system 1 comprising a cellular system, for example, a 3GPP wireless communication system. The wireless communication system 1 comprises a wireless device 300 and/or a network node 400.

A network node disclosed herein refers to a radio access network node operating in the radio access network, such as a base station, an evolved Node B, eNB, gNB.

The wireless communication system 1 described herein may comprise one or more wireless devices 300, 300A, and/or one or more network nodes 400, such as one or more of: a base station, an eNB, a gNB and/or an access point. In one or more embodiments, RAN node is a functional unit which may be distributed in several physical units.

A wireless device may refer to a mobile device and/or a user equipment, UE.

The wireless device 300, 300A may be configured to communicate with the network node 400 via a wireless link (or radio access link) 10, 10A.

In 3GPP Release 16 (such as TS 38.331 v16.1.0 section 5.7.4) a functionality called UE assistance information signaling is introduced. With UE assistance information signalling, a wireless device which is already in connected mode can transmit its preferences for a set of UE parameters configurable by the network node. The existing function presents drawbacks. For example, a drawback is the amount of signaling required for a UE to be able to indicate its preference of the UE parameters. For example, the wireless device is only being able to transmit UE assistance information while already having an RRC connection setup and being active using the RRC connected state for the signaling. This requires the time to perform the RRC connection setup: the network node needs to setup an RRC connection with a set of parameters and confirmation based on the network node choice; once the network node further configures the wireless device to be allowed to transmit UE assistance information, the wireless device can indicate its preferences

Several of the UE parameters have an impact on power consumption of the wireless device during the connection. Alternatively, or additionally, the selection of UE parameters may impact the performance of the data transmission occurring while the wireless device is in a connected state.

UE parameters may comprise radio parameters used to configure the wireless device. UE parameters (e.g. for New Radio, NR—included into different parts of the new radio specifications such as physical layer parameters in 38.211, 38.212, 38.213 versions 16.1.0 or RRC parameters in TS 38.331 v16.1.0) may include one or more of: bandwidth part, BWP, configurations, Discontinuous Reception, DRX, configurations, number of Multiple Input Multiple Output, MIMO layers, number of active carriers, frequency bands, and radio access technology combinations (dual connectivity) used. The UE parameters are configurable by a network node. For example, some UE parameters are semi-static configured with Radio Resource Control, RRC, configuration signaling, such as BWP configurations, number of carriers and DRX settings. For example, some UE parameters are physical layer specific, and may be configured via Downlink Control Information, DCI, during data scheduling, such as modulation scheme and MIMO layers. For example, the selection of the parameter may impact the achievable data rate, the variation of the data rate, the end to end packet latency.

It may be noted that legacy methods for UE assistance information to support network due to overheat, in-device coexistence indication and power consumption adaptation is available in TS 38.331 v16.1.0 for NR. Similar signaling for overheat and in-device coexistence indication is available in TS 36.331 v16.1.0 for Long Term Evolution, LTE.

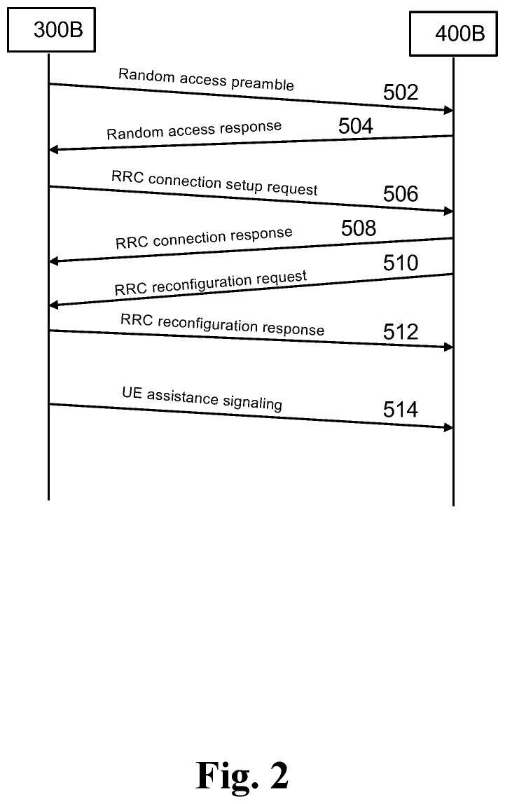

FIG. 2 shows a signalling diagram illustrating legacy signalling for enabling UE assistance. With the legacy signalling for enabling UE assistance, a wireless device which is already in connected mode can transmit its preferences for the UE parameters configurable by the network node. With the legacy signalling, the network node needs to have an RRC connection setup with a set of parameters and confirmation based on the network node choice. Different signaling may be conducted to setup an RRC connection. One example is illustrated in FIG. 2, where an example using a so-called four step random access procedure is shown. As illustrated in FIG. 2, this example requires the wireless device 300B and the network node 400B to communicate random access preamble 502, random access response 504, RRC connection setup request 506, RRC connection response 508. The RRC connection is now established and the wireless device 300 is in connected mode.

When the wireless device is communicating in RRC connected state, the network node 400B may configure the wireless device to allow UE assistance information: the network node 400B sends to the wireless device 300B RRC reconfiguration request 510 and receives from the wireless device 300B RRC reconfiguration response. The wireless device 300B can then send UE assistance signalling 514 to indicate a radio parameter. It is only once the network node 400B configures the wireless device 300B to be allowed to transmit UE assistance information, e.g. as part of the RRC configuration procedure, the wireless device 300B can indicate its radio preferences, which may lead to reduced power consumption and possibly improved performance.

As illustrated in FIG. 2, the legacy signalling requires an amount of signaling which takes time. The legacy procedure for UE providing assistance information is limited to the case of providing assistance for an already ongoing session in RRC connected state. Also, the signaling procedure can be simplified. With respect to the limitation to an ongoing session in RRC connected, the legacy signalling provides room for improvement as it can be seen in the order and timing of the signaling.

The present disclosure provides a technique that improves the UE assistance signalling, in terms of timing, order and thereby allows for improvement in terms of performance and power consumption for the wireless device. The signalling disclosed herein is also more efficient in terms of amount of signalling exchanged, order and timing, than the legacy signalling.

The disclosed technique provides a benefit in terms of the RRC connection optimization procedure by providing the network node UE assistance information about the UE preferences for the upcoming data transmission session (such as the session being setup) during the connection establishment procedure. The benefits may include a reduced latency. For example, the network node may otherwise e.g. configure the session with less carriers or less bandwidth than suitable and the network node needs to further adjust later based on the session needs. It may be appreciated that each re-configuration takes time, so if one or more reconfigurations are required to optimize, this creates additional delay, which the present disclosure addresses.

The disclosed technique may be applied to adapt parameters for usage in a connected mode of a wireless device. A connected mode may be referred to as an operation mode wherein a data transmission can be communicated e.g. between the wireless device and a network node or between the wireless device and another wireless device. A connected mode may be referred to as an operation state wherein a radio transmitter and/or a radio receiver is activated for such communication. A connected mode may be referred to as an operation state wherein the wireless device is synchronized time-wise and/or frequency-wise e.g. by a determined timing advance parameter for the communication. In certain communication systems, a connected mode may be referred to a radio resource control (RRC) state. In various examples, an active state may be a RRC connected state and/or an RRC active state. However, a connected mode may be an active period within another RRC state. The disclosed technique may be applied to allow the wireless device to transmit UE assistance information to the network node prior to usage of the connected mode for data communication.

The benefits may include a reduced power consumption. For example, the network node otherwise initially configures the RRC connection with parameters not suitable from a UE power consumption perspective based on the data traffic pattern for the existing RRC connected session. This creates unnecessary power consumption by the wireless device which the disclosed technique helps prevent.

The benefits may relate to the amount of signaling: the legacy signaling protocol addresses UE assistance by asking the UE to provide suitable parameters among a fixed (hardcoded in standard) wide range per parameter. In the legacy technique, for each indicated UE parameter, there is a large amount of signaling bits required in order to cover all signaling options. In order to reduce the signaling load, a more efficient scheme is disclosed herein.

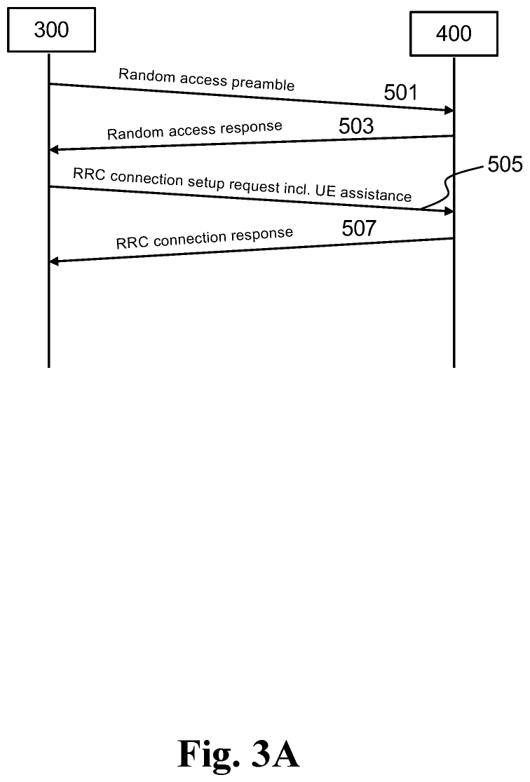

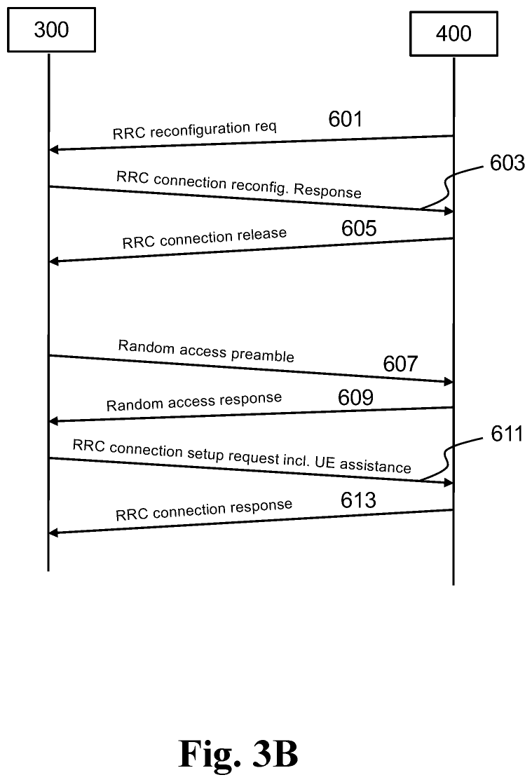

An example procedure according to this disclosure as illustrated in FIG. 3. This disclosed signaling procedure may be added to the specifications as an add-on, that may be used as a complement to the existing specifications.

FIGS. 3A-3B are signalling diagrams illustrating example signalling exchanges for UE assistance information according to this disclosure,

In FIG. 3A, the wireless device 300 transitioning from a dormant RRC state (such as RRC idle or RRC inactive) into a RRC connected state transmits to the network node 400 a Random access preamble 501. The network node 400 transmits to the wireless device 300 a Random access response 502.

In this example, the wireless device 300 transitioning from a dormant RRC state (such as RRC idle or RRC inactive) into a RRC connected state transmits to the network node 400, as part of the RRC connection setup request 505, UE assistance information associated with a radio parameter for use in the RRC connected mode.

The network node 400 transmits to the wireless device 300 a RRC connection response 507.

In other words, during the signaling procedure of a wireless device 300 transitioning from a dormant RRC state (such as RRC idle, RRC suspend or RRC inactive) into a RRC connected state, the wireless device 300 informs the network node 400 of one or more power consumption and/or radio link performance related settings, as a mode selection signaling. The UE assistance information informs the network node 400 about a UE radio configuration such as a preferred UE radio configuration for the upcoming occasion of being in RRC connected. Prior to such signaling, the wireless device 300 may have been informed about available radio parameter settings to select from in its indication. The radio parameter settings information may have been provided to the wireless device during an earlier occasion of being in RRC connected, or via other network signaling methods such as via system information.

The timing drawback of the legacy functionality may be seen as addressed by the disclosed technique allowing to provide UE assistance information (such as a UE-indication of a suitable parameter set) for an upcoming RRC connected state session into the signaling flow for the state change. This allows the wireless device to consider UE internal information that the wireless device may have available about the upcoming data transmission needs, and to recommend a radio parameter set for the upcoming session based on the UE internal information. This may be e.g. based on information the UE may have about one or more applications in the UE demanding data traffic. One may for example consider the wireless device to be one or more of: an Internet-of-things, IoT, device or an “industrial IoT” device, a video streaming device, a gaming device. The wireless device may be seen as having a-priori knowledge about optimal settings based on expected data traffic for a session.

The signaling during the state change could be part of any message of the connection establishment procedure, such as part of a random access procedure, such as part of an RRC connection procedure, such as part of RRC connection resume procedure.

In FIG. 3B, the network node 400 transmits to the wireless device 300 a RRC reconfiguration request 601 while the wireless device 300 is in connected mode.

The wireless device 300 transmits to the network node 400 a RRC reconfiguration response 603, indicating that the wireless device 300 requests to store (e.g. save) the present radio parameter(s) (or radio parameter configuration) with an indicator of flag for future use or future reference in signalling. The network node 400 transmits to the wireless device 300 a RRC connection release 605, which sends the wireless device 300 into RRC Idle mode. In FIG. 3B, the wireless device 300 or the network node 400 can during a RRC configuration/reconfiguration signaling include a “save” command (such as in 603), with a reference to an indicator number. The configuration can then be re-used when/if referring back to the same configuration again.

In FIG. 3B, the wireless device 300 transitioning from a dormant RRC state (such as RRC idle or RRC inactive) into a RRC connected state transmits to the network node 400 a Random access preamble 607. The network node 400 transmits to the wireless device 300 a Random access response 609.

In this example, the wireless device 300 transitioning from a RRC idle into a RRC connected state transmits to the network node 400, as part of the RRC connection setup request 505, UE assistance information associated with a radio parameter for use in the RRC connected mode, which refers to the radio parameter of the previous session (which was saved by the network node in response to 603).

The network node 400 transmits to the wireless device 300 a RRC connection response 613 for completing the session setup for a session suing the radio parameter(s) used in the previous session.

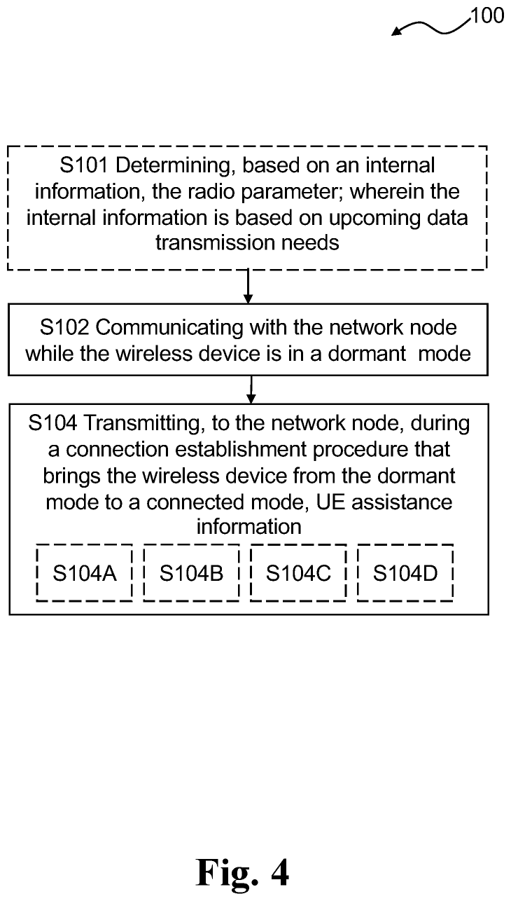

FIG. 4 is a flow-chart illustrating an example method 100, performed by a wireless device, for providing UE assistance information to a network node according to this disclosure, The UE assistance information may be seen as assistance information provided by the wireless device to assist the network node in establishing the connection with the wireless device.

The example method 100, performed by a wireless device, according to this disclosure (e.g. the wireless device disclosed herein, such as wireless device 300 of FIGS. 1, 3, and 6).

The method 100 comprises communicating S102 with the network node while the wireless device is in a dormant mode. The dormant mode is a mode where the UE has no active connection with the network node. A dormant mode may be seen as an inactive mode of the wireless device. A dormant mode may be seen as a mode where the wireless device is unsynchronized with a timing of a network. In one or many examples the wireless device may in a dormant mode not have a valid timing advance information with respect to the network. A dormant mode may be seen as a mode where the wireless device is unable to receive dedicated signaling. A dormant mode may be seen as a mode where closed loop power control is inactivated or suspended. Dormant mode may comprise RRC idle mode, RRC suspend and/or RRC inactive mode. For example, the wireless device may be in dormant mode when the connection with the network node has been released and/or suspended.

The method 100 comprises transmitting S104, to the network node, during a connection establishment procedure or a connection reactivation procedure that brings the wireless device from the dormant mode to a connected mode, UE assistance information associated with a radio parameter for use in the connected mode. A connection establishment procedure may include an RRC connection establishment procedure, and/or a re-activation procedure, and/or a resumption procedure. For example, the wireless device transmits, to the network node, as part of the connection establishment procedure that brings the wireless device from the dormant mode to a connected mode, the UE assistance information associated with a radio parameter for use in the connected mode. In other words, the UE assistance information associated with a radio parameter for use in the connected mode is provided by the wireless device within the connection establishment procedure that brings the wireless device from the dormant mode to a connected mode. Stated differently, the transmitting takes place during the connection establishment procedure that brings the wireless device from the dormant mode to a connected mode, and thereby before the connection is established. Connected mode comprises for example actively communicating signaling within RRC connected mode. A connected mode may be referred to as an operation mode wherein a data transmission can be communicated e.g. between the wireless device and a network node or between the wireless device and another wireless device. A connected mode may be referred to as an operation state wherein a radio transmitter and/or a radio receiver is activated for such communication. A connected mode may be referred to as an operation state wherein the wireless device is synchronized time-wise and/or frequency-wise e.g. by a determined timing advance parameter for the communication. In certain communication systems, a connected mode may be referred to a radio resource control (RRC) state. In various examples, an active state may be a RRC connected state and/or an RRC active state. However, a connected mode may be an active period within another RRC state.

The signaling of the UE assistance information may be provided at occasions as illustrated in FIGS. 3A and 3B, but other signaling examples may also be applicable. As one example, signaling of UE assistance information during an initial access procedure other than the random access procedure sequence illustrated in FIGS. 3A-3B may be applied. A two-step random access procedure may be applied where less signaling steps may be applied compared to the illustrations. Signaling during a different mode switching may be executed, e.g. in a connection procedure without random access such as during a pre-configured uplink transmission in idle mode, or during a transition from a dormant RRC mode to an active RRC mode. In one or more examples, an ongoing connection may be suspended or inactivated, bringing the wireless device to a dormant mode. The wireless device or the network node may transmit a resume message and/or a re-activation message to use the connection again. In such case, the procedures illustrated in FIG. 2, 3A, 3B may not be used for the re-activation of the connection. Still, in one or more examples, the UE assistance information may be transmitted within or related to a resume message and/or a re-activation message, to assist the network node to configure the radio parameter(s) during the usage of the re-activated connection and/or the resumed connection.

The UE assistance information may be associated with one or more radio parameters, such as associated with a radio parameter configuration, such as associated with a radio parameter set including a first radio parameter.

In one or more example methods, the UE assistance information is indicative of the radio parameter. In one or more example methods, the radio parameter comprises one or more of: a bandwidth part configuration parameter, a DRX configuration parameter, a number of MIMO layers, a number of active carriers, one or more frequency bands, a combination of radio access technologies used, a dual connectivity parameter, a modulation scheme parameter, and a previously used radio parameter. The radio parameter may be seen as a radio parameter preferred, or desired, or requested by the wireless device, due to internal information regarding upcoming communication needs.

The disclosed technique provides a benefit in terms of the connection optimization procedure by providing the network node UE assistance information about the UE preferences for the upcoming data transmission session (such as the session being setup) during the connection establishment procedure. The disclosed technique results in a reduced latency in setting up the appropriate session for the wireless device in terms of power consumption and/or performance. This may lead to a reduced power consumption at the wireless device.

In one or more example methods, the transmitting S104 comprises transmitting S104A the UE assistance information to the network node before the connection is established or re-established. For example, the UE assistance information may be transmitted as part of RRC connection setup request as illustrated in FIG. 3. For example, the UE assistance information may be transmitted as part of a RRC connection resume procedure before the connection is re-established. In one or more example methods, the transmitting S104 comprises transmitting S104C, to the network node, the UE assistance information associated with the radio parameter within a Radio Resource Control, RRC, resume procedure.

In one or more example methods, the transmitting S104 comprises transmitting S104B the UE assistance information to the network node in a random access procedure. For example, the UE assistance information may be transmitted during or as part of the random access procedure, such as in any messages of the random access procedure. In one or more example methods, the UE assistance information associated with the radio parameter is included in a third message, MSG3, of the random access procedure. For example, the signaling of UE assistance information during the state change from idle mode to connected mode can be part of a random access procedure, where the indication is included into the so-called “message 3”. The first message in the random access procedure is the UE transmitting a random access preamble. The second message of the random access procedure is the network responding to the random access preamble, such as in a random access response.

In one or more example methods, the transmitting S104 comprises transmitting S104D the UE assistance information associated with the radio parameter to the network node in a pre-configured uplink data transmission. For example, of UE assistance information during state change may be part of a transmission during so-called pre-configured uplink resources, PUR, where the wireless device can transmit small amount of data while being in Idle mode. For example, the wireless device is in Idle mode but does not have to use the random access procedure but can use the PUR for transmitting the UE assistance information. When the wireless device or network node intends to transmit additional data on top of the ability from a pre-configured resource, the procedure can continue after PUR into a RRC connected mode.

In one or more example methods, the UE assistance information comprises information for configuring an upcoming connection between the wireless device and the network node (e.g. during RRC connection setup, and/or during a re-activation from an inactive and/or dormant state of an ongoing RRC connection). For example, to reduce the signaling load, the signaling of UE assistance information (e.g. associated with a suitable parameter set for an upcoming RRC connected state session) can be based on combining a set of parameter values into a configuration set. In the a-priori indication, this may lead to reduce the amount of signaling by only referring to the configuration set instead of providing all the values.

In one or more example methods, the upcoming connection is a resumed connection or a new connection.

In one or more example methods, the UE assistance information comprises a flag referring to the radio parameter. This may be seen as an implicit signalling, reducing the signalling overhead. The flag may be seen as an implicit signalling of the radio parameter. For example, the flag may refer to a combination of set of parameters with a configuration set. This reduces the amount of signaling by only referring to the configuration set instead of providing all the values.

In one or more example methods, the UE assistance information comprises the radio parameter. This may be seen as an explicit form of signalling. For example, the network node may explicitly indicate a set of configurations that the wireless device is allowed to select between, upon entering the RRC connected state. The configuration set information can preferably be signaled as part of RRC signaling (during a first RRC connected mode session) and utilized for a second RRC connected mode session. For example, a new RRC message may be used for introducing the options to select between, such as an RRC message as part of the UE assistance configuration section in TS 38.331.

In one or more example methods, the UE assistance information comprises a flag referring to a radio parameter configuration used in an earlier connected mode session. A connected mode session may be seen as a session in connected mode. For example, as illustrated in FIG. 3B, the wireless device can explicitly indicate its preference to use one previously utilized radio parameter configuration. A few bits in the UE assistance signaling can be used for indicating one of the stored configurations (for example, using two bits allows for indication of one out of four configurations).

In one or more example methods, when the wireless device transfers from an idle mode to a connected mode, the UE assistance information comprises a flag referring to a radio parameter configuration used in the previously connected mode session. The previously used radio parameter configuration may be the last configuration used in some embodiments.

In one or more example methods, when the wireless device transfers from an inactive mode to a connected mode, the UE assistance information comprises a flag referring to a radio parameter configuration used in a previous connected mode session which is earlier than the previously connected mode session (such as earlier than the immediately preceding connected mode session). The previously used radio parameter may be a configuration utilized in one or more RRC connected sessions earlier than the previous session in some embodiments.

In one or more example methods, the method 100 comprises determining S101, based on an internal information, the radio parameter. In one or more example methods, the internal information is based on upcoming data transmission needs. For example, the upcoming data transmission needs may be based on one or more applications in the wireless device demanding data traffic. One may for example consider an IoT device or an “industrial IoT” device, or a video streaming device, or a gaming device having a-priori knowledge about optimal settings based on expected data traffic for a session.

In one or more example methods, the method 100 comprises communicating (e.g. transmitting and/or receiving), between the wireless device and the network node, using the radio parameter indicated in the UE assistance information of S104.

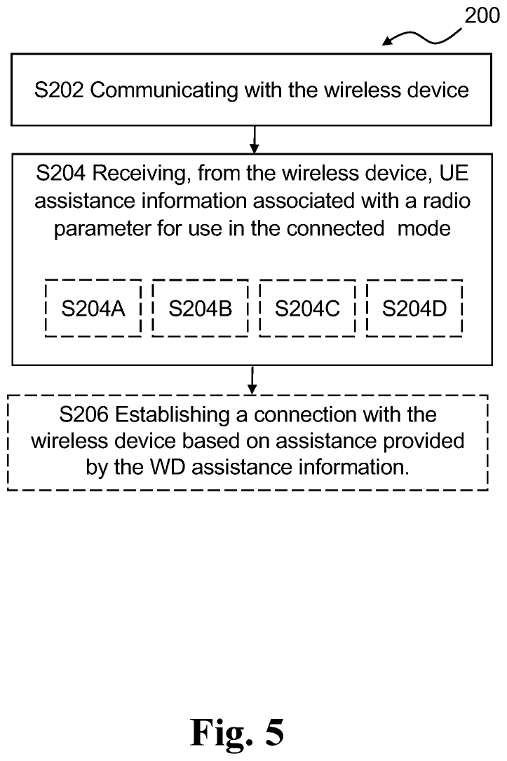

FIG. 5 is a flow-chart illustrating an example method 200, performed by a network node, for receiving User Equipment, UE, assistance information from a wireless device in a dormant mode according to this disclosure. The example method 200 is performed by a network node according to this disclosure (such as the network node disclosed herein, such as network 400 of FIGS. 1, 3, and 7).

The method 200 comprises communicating S202 with the wireless device. The wireless device is in a dormant mode, such as Idle mode, Suspend mode, and/or Inactive mode, such as RRC Idle mode, RRC suspend and/or RRC Inactive mode. This corresponds to S102 of FIG. 4.

The method 200 comprises receiving S204, from the wireless device, UE assistance information associated with a radio parameter for use in the connected mode, such as RRC connected mode. The receiving S204 is performed during the connection establishment procedure that brings the wireless device from the dormant mode to a connected mode. This corresponds to S104 of FIG. 4. The UE assistance information may be associated with one or more radio parameters, such as associated with a radio parameter configuration, such as associated with a radio parameter set including a first radio parameter. In one or more example methods, the radio parameter comprises one or more of: a bandwidth part configuration parameter, a DRX configuration parameter, a number of MIMO layers, a number of active carriers, one or more frequency bands, a combination of radio access technologies used, a dual connectivity parameter, a modulation scheme parameter, and a previously used radio parameter. For example, the network node receives, from the wireless device, as part of the connection establishment procedure that brings the wireless device from the dormant mode to a connected mode, the UE assistance information associated with a radio parameter for use in the connected mode. In other words, the UE assistance information associated with a radio parameter for use in the connected mode is received from the wireless device within the connection establishment procedure that brings the wireless device from the dormant mode to a connected mode. Stated differently, the reception of the UE assistance information takes place during the connection establishment procedure that brings the wireless device from the dormant mode to a connected mode, and thereby before the connection is established. Connected mode comprises for example RRC connected mode.

In one or more example methods, receiving S204, from the wireless device, the UE assistance information associated with the Radio parameter for use in connected mode comprises receiving S204A, from the wireless device, the UE assistance information associated with the radio parameter before the connection is established or re-established. This corresponds to S104A of FIG. 4.

In one or more example methods, receiving S204, from the wireless device, the UE assistance information associated with the radio parameter for use in connected mode comprises receiving S204B, from the wireless device, the UE assistance information associated with the radio parameter within a random access procedure. This corresponds to S104B of FIG. 4. In one or more example methods, the UE assistance information associated with the radio parameter is included a third message 3, MSG3, of the random access procedure.

In one or more example methods, receiving S204, from the wireless device, the UE assistance information associated with the radio parameter for use in connected mode comprises receiving S204C, from the wireless device, the UE assistance information associated with the radio parameter within a Radio Resource Control, RRC, resume procedure. This corresponds to S1040 of FIG. 4.

In one or more example methods, receiving S204, from the wireless device, the UE assistance information associated with the radio parameter for use in connected mode comprises receiving S204D, from the wireless device, the UE assistance information associated with the radio parameter within a pre-configured uplink data transmission.

In one or more example methods, the UE assistance information comprises information for configuring an upcoming connection. For example, to reduce the signaling load, the signaling of UE assistance information (e.g. associated with a suitable parameter set for an upcoming RRC connected state session) can be based on combining a set of parameter values into a configuration set. In the a-priori indication, this may lead to reduce the amount of signaling by only referring to the configuration set instead of providing all the values.

In one or more example methods, the upcoming connection is a resumed connection or a new connection.

In one or more example methods, the UE assistance information is indicative of the radio parameter.

In one or more example methods, the UE assistance information comprises a flag referring to the radio parameter. This may be seen as an implicit signalling, reducing the signalling overhead. The flag may be seen as an implicit signalling of the radio parameter. For example, the flag may refer to a combination of set of parameters with a configuration set. This reduces the amount of signaling by only referring to the configuration set instead of providing all the values.

In one or more example methods, the UE assistance information comprises the radio parameter. This may be seen as an explicit form of signalling. For example, the network node may explicitly indicate a set of configurations that the wireless device is allowed to select between, upon entering the RRC connected state. The configuration set information can preferably be signaled as part of RRC signaling (during a first RRC connected mode session) and utilized for a second RRC connected mode session. For example, a new RRC message may be used for introducing the options to select between, such as an RRC message as part of the UE assistance configuration section in TS 38.331.

In one or more example methods, the UE assistance information comprises a flag referring to a radio parameter configuration used in an earlier connected mode session. A connected mode session may be seen as a session in connected mode. For example, as illustrated in FIG. 3B, the wireless device can explicitly indicate its preference to use one previously utilized radio parameter configuration. A few bits in the UE assistance signaling can be used for indicating one of the stored configurations (for example, using two bits allows for indication of one out of four configurations).

In one or more example methods, when the wireless device transfers from an idle mode to a connected mode, the UE assistance information comprises a flag referring to a radio parameter configuration used in the previously connected mode session. The previously used radio parameter configuration may be the last configuration used in some embodiments.

In one or more example methods, when the wireless device transfers from an inactive mode to a connected mode, the UE assistance information comprises a flag referring to a radio parameter configuration used in a previous connected mode session which is earlier than the previously connected mode session (such as earlier than the immediately preceding connected mode session). The previously used radio parameter may be a configuration utilized in one or more RRC connected sessions earlier than the previous session in some embodiments.

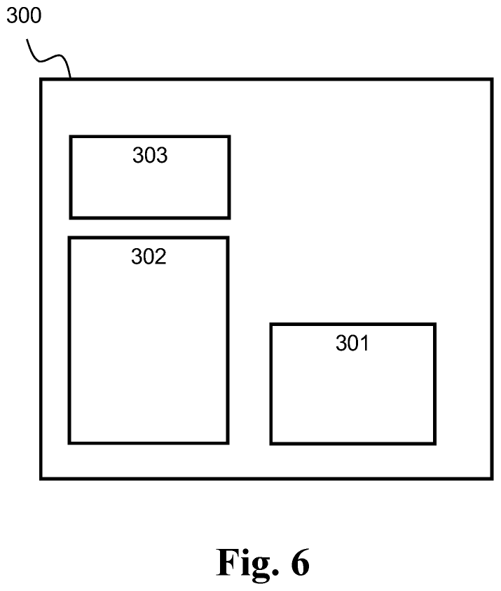

In one or more example methods, the method comprises establishing S206 a connection with the wireless device based on assistance provided by the UE assistance information. FIG. 6 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIG. 4. In other words, the wireless device 300 may be configured for providing User Equipment, UE, assistance information to a network node.

The wireless device 300 is configured to communicate (such as via the wireless interface 303) with a network node, such as the network node disclosed herein, while the wireless device is in a dormant mode.

The wireless device 300 is configured to transmit (such as via the wireless interface 303) to a network node, such as the network node disclosed herein, during a connection establishment procedure that brings the wireless device from the dormant mode to a connected mode, UE assistance information associated with a radio parameter for use in the connected mode.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M.

The wireless device 300 is optionally configured to perform any of the operations disclosed in FIG. 4 (such as any one or more of S104A, S104B, S104C, S104D, S106). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may as well be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 6). Memory circuitry 301 is considered a non-transitory computer readable medium.

Memory circuitry 301 may be configured to store information (such as UE assistance information) in a part of the memory.

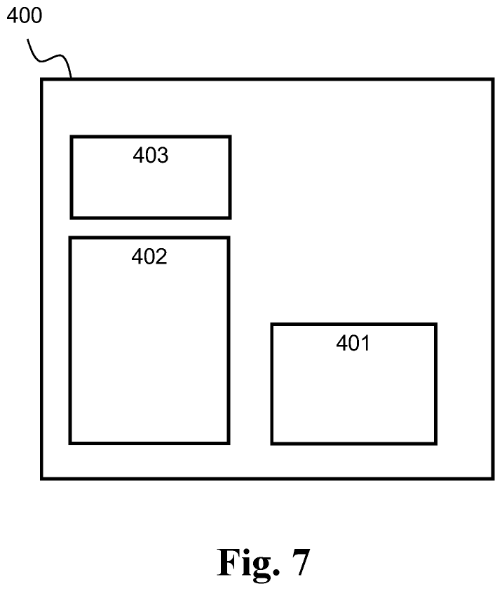

FIG. 7 shows a block diagram of an example network node 400 according to the disclosure. The network node 400 comprises memory circuitry 401, processor circuitry 402, and a wireless interface 403. The network node 400 may be configured to perform any of the methods disclosed in FIG. 5. In other words, the network node 400 may be configured for receiving User Equipment, UE, assistance information from a wireless device in a dormant mode.

The network node 400 is configured to communicate with a wireless device while the wireless device is in dormant mode, such as the wireless device disclosed herein, for example, using a wireless communication system.

The network node 400 is configured to receive (such as via the wireless interface 403), from the wireless device, UE assistance information associated with a radio parameter for use in the connected mode, e.g. during connection establishment procedure that brings the wireless device from the dormant mode to the connected mode.

The wireless interface 403 is configured for wireless communications via a wireless communication system, such as a 3GPP system, such as a 3GPP system supporting millimeter-wave communications, such as millimeter-wave communications in licensed bands, such as device-to-device millimeter-wave communications in licensed bands.

Processor circuitry 402 is optionally configured to perform any of the operations disclosed in FIG. 5 (such as any one or more of S204A, S204B, S204C, S204D, S206). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may as well be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 7). Memory circuitry 401 is considered a non-transitory computer readable medium.

Memory circuitry 401 may be configured to store, UE, assistance information, such as a radio parameter, in a part of the memory.

Embodiments of methods and products (network node and wireless device) according to the disclosure are set out in the following items:
Item 1. A method, performed by a wireless device, for providing User Equipment, UE, assistance information to a network node, the method comprising:
   communicating (S102) with the network node while the wireless device is in a dormant mode; and
   transmitting (S104), to the network node, during a connection establishment procedure that brings the wireless device from the dormant mode to a connected mode, UE assistance information associated with a radio parameter for use in the connected mode.
Item 2. The method according to item 1, wherein the transmitting (S104) comprises transmitting (S104A) the UE assistance information to the network node before the connection is established or re-established.
Item 3. The method according to any of the previous items, wherein the transmitting (S104) comprises transmitting (S104B) the UE assistance information to the network node in a random access procedure.
Item 4. The method according to item 3, wherein the UE assistance information associated with the radio parameter is included in a third message, MSG3, of the random access procedure.
Item 5. The method according to any of the previous items, wherein the transmitting (S104) comprises transmitting (S104C), to the network node, the UE assistance information associated with the radio parameter within a Radio Resource Control, RRC, resume procedure.
Item 6. The method according to any of the previous items, wherein the transmitting (S104) comprises transmitting (S104D) the UE assistance information associated with the radio parameter to the network node in a pre-configured uplink data transmission.
Item 7. The method according to any of the previous items, wherein the UE assistance information comprises information for configuring an upcoming connection between the wireless device and the network node.
Item 8. The method according to item 7, wherein the upcoming connection is a resumed connection or a new connection.
Item 9. The method according to any of the previous items, wherein the UE assistance information is indicative of the radio parameter.
Item 10. The method according to any of the previous items, wherein the UE assistance information comprises a flag referring to the radio parameter.
Item 11. The method according to any of the previous items, wherein the UE assistance information comprises the radio parameter.
Item 12. The method according to any of the previous items, wherein the radio parameter comprises one or more of: a bandwidth part configuration parameter, a DRX configuration parameter, a number of MIMO layers, a number of active carriers, one or more frequency bands, a combination of radio access technologies used, a dual connectivity parameter, a modulation scheme parameter, and a previously used radio parameter.
Item 13. The method according to any of the previous items, wherein the UE assistance information comprises a flag referring to a radio parameter configuration used in an earlier connected mode session.
Item 14. The method according to any of the previous items, wherein when the wireless device transfers from an idle mode to a connected mode, the UE assistance information comprises a flag referring to a radio parameter configuration used in the previously connected mode session.
Item 15. The method according to any of the previous items, wherein when the wireless device transfers from an inactive mode to a connected mode, the UE assistance information comprises a flag referring to a radio parameter configuration used in a connected mode session which is earlier than the previously connected mode session.
Item 16. The method according to any of the previous items, the method comprising:
   determining (S106), based on an internal information, the radio parameter; wherein the internal information is based on upcoming data transmission needs.
Item 17. A method, performed by a network node, for receiving wireless device, WD, assistance information (e.g. UE assistance information) from a wireless device in a dormant mode, the method comprising:
   communicating (S202) with the wireless device; and
   receiving (S204), from the wireless device, e.g. during a connection establishment procedure that brings the wireless device from the dormant mode to a connected mode, UE assistance information associated with a radio parameter for use in the connected mode.
Item 18. The method according to item 17, wherein receiving (S204), from the wireless device, the UE assistance information associated with the Radio parameter for use in connected mode comprises receiving (S204A), from the wireless device, the UE assistance information associated with the radio parameter before the connection is established or re-established.
Item 19. The method according to any of items 17-18, wherein receiving (S204), from the wireless device, the UE assistance information associated with the radio parameter for use in connected mode comprises receiving (S204B), from the wireless device, the UE assistance information associated with the radio parameter in a random access procedure.
Item 20. The method according to item 19, wherein the UE assistance information associated with the radio parameter is included a third message, MSG3, of the random access procedure.
Item 21. The method according to any of items 17-20, wherein receiving (S204), from the wireless device, the UE assistance information associated with the radio parameter for use in connected mode comprises receiving (S204C), from the wireless device, the UE assistance information associated with the radio parameter within a Radio Resource Control, RRC, resume procedure.
Item 22. The method according to any of items 17-21, wherein receiving (S204), from the wireless device, the UE assistance information associated with the radio parameter for use in connected mode comprises receiving (S204D), from the wireless device, the UE assistance information associated with the radio parameter within a pre-configured uplink data transmission.
Item 23. The method according to any of items 17-22, wherein the UE assistance information comprises information for configuring an upcoming connection.
Item 24. The method according to item 23, wherein the upcoming connection is a resumed connection or a new connection.
Item 25. The method according to any of items 17-24, wherein the UE assistance information is indicative of the radio parameter.
Item 26. The method according to any of items 17-25, wherein the UE assistance information comprises a flag referring to the radio parameter.
Item 27. The method according to any of items 17-26, wherein the UE assistance information comprises the radio parameter.
Item 28. The method according to any of items 17-27, wherein the radio parameter comprises one or more of: a bandwidth part configuration parameter, a DRX configuration parameter, a number of MIMO layers, a number of active carriers, one or more frequency bands, a combination of radio access technologies used, a dual connectivity parameter, a modulation scheme parameter, and a previously used radio parameter.
Item 29. The method according to any of items 17-28, the method comprising establishing (S206) a connection with the wireless device based on assistance provided by the UE assistance information.
Item 30. A wireless device comprising a memory circuitry, a processor circuitry, and a wireless interface, wherein the wireless device is configured to perform any of the methods according to any of items 1-16.
Item 31. A network node comprising memory circuitry, processor circuitry, and wireless interface, wherein the network node is configured to perform any of the methods according to any of items 17-29.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-7 comprises some circuitries or operations which are illustrated with a solid line and some circuitries or operations which are illustrated with a dashed line. Circuitries or operations which are comprised in a solid line are circuitries or operations which are comprised in the broadest example embodiment. Circuitries or operations which are comprised in a dashed line are example embodiments which may be comprised in, or a part of, or are further circuitries or operations which may be taken in addition to circuitries or operations of the solid line example embodiments. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the example embodiments may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a wireless device, for providing User Equipment (UE) assistance information to a network node, the method comprising:
communicating with the network node while the wireless device is in a dormant mode; and
transmitting, to the network node, during a connection establishment procedure that brings the wireless device from the dormant mode to a connected mode, UE assistance information associated with a radio parameter for use in the connected mode.

2. The method according to claim 1, wherein the transmitting comprises transmitting the UE assistance information to the network node before the connection is established or re-established.

3. The method according to claim 1, wherein the transmitting comprises transmitting the UE assistance information to the network node in a random access procedure.

4. The method according to claim 3, wherein the UE assistance information associated with the radio parameter is included in a third message (MSG3) of the random access procedure.

5. The method according to claim 1, wherein the transmitting comprises transmitting, to the network node, the UE assistance information associated with the radio parameter within a Radio Resource Control (RRC) resume procedure.

6. The method according to claim 1, wherein the transmitting comprises transmitting the UE assistance information associated with the radio parameter to the network node in a pre-configured uplink data transmission.

7. The method according to claim 1, wherein the UE assistance information comprises information for configuring an upcoming connection between the wireless device and the network node.

8. The method according to claim 7, wherein the upcoming connection is a resumed connection or a new connection.

9. The method according to claim 1, wherein the UE assistance information is indicative of the radio parameter.

10. The method according to claim 1, wherein the UE assistance information comprises a flag referring to the radio parameter.

11. The method according to claim 1, wherein the UE assistance information comprises the radio parameter.

12. The method according to claim 1, wherein the radio parameter comprises one or more of: a bandwidth part configuration parameter, a DRX configuration parameter, a number of MIMO layers, a number of active carriers, one or more frequency bands, a combination of radio access technologies used, a dual connectivity parameter, a modulation scheme parameter, and a previously used radio parameter.

13. The method according to claim 1, wherein the UE assistance information comprises a flag referring to a radio parameter configuration used in an earlier connected mode session.

14. The method according to claim 1, wherein when the wireless device transfers from an idle mode to a connected mode, the UE assistance information comprises a flag referring to a radio parameter configuration used in the previously connected mode session.

15. The method according to claim 1, wherein when the wireless device transfers from an inactive mode to a connected mode, the UE assistance information comprises a flag referring to a radio parameter configuration used in a connected mode session which is earlier than the previously connected mode session.

16. The method according to claim 1, the method comprising: determining, based on an internal information, the radio parameter; wherein the internal information is based on upcoming data transmission needs.

17. A method, performed by a network node, for receiving User Equipment (UE) assistance information from a wireless device in a dormant mode, the method comprising:
communicating with the wireless device; and
receiving, from the wireless device, during a connection establishment procedure that brings the wireless device from the dormant mode to a connected mode, UE assistance information associated with a radio parameter for use in the connected mode.

18. The method according to claim 17, wherein receiving, from the wireless device, the UE assistance information associated with the Radio parameter for use in connected mode comprises receiving, from the wireless device, the UE assistance information associated with the radio parameter before the connection is established or re-established.

19. The method according to claim 17, wherein receiving, from the wireless device, the UE assistance information associated with the radio parameter for use in connected mode comprises receiving-, from the wireless device, the UE assistance information associated with the radio parameter in a random access procedure.

20. The method according to claim 19, wherein the UE assistance information associated with the radio parameter is included a third message (MSG3) of the random access procedure.

21-31. (canceled)
